(19) United States
(12) Patent Application Publication
(10) Pub. No.: US 2012/0112624 A1
(43) Pub. Date: May 10, 2012

(54) XENON LAMP USING CERAMIC ARC TUBE

(75) Inventor: Poong Gi Jeong, Jeonju (KR)

(73) Assignees: KAIXEN CO., LTD., JEONJU, JEONBUK (KR); POONG GI JEONG, JEONJU, JEONBUK (KR)

(21) Appl. No.: 13/382,428

(22) PCT Filed: Jul. 27, 2009
(86) PCT No.: PCT/KR09/04153

§ 371 Date: Jan. 18, 2012

(30) Foreign Application Priority Data
Jul. 6, 2009 (KR) 10-2009-0061105

(51) Int. Cl. H01J 61/16; H01J 61/44

(52) U.S. Cl. 313/493

(57) ABSTRACT

The present invention relates to a xenon lamp using a ceramic arc tube, and more specifically to a xenon lamp using a ceramic arc tube, which can provide an extended life of at least 10 times longer than a glass tube xenon lamp, by using an arc tube to form a ceramic body made from ceramics, instead of using a circular glass tube to form the xenon lamp, and which is also applicable to all xenon lamps.

### CROSS REFERENCE TO RELATED APPLICATION

The present application claims all benefits accruing under 35 U.S.C. §365(c) from the PCT International Application PCT/KR2009/004153, with an International Filing Date of Jul. 27, 2009, which claims the benefit of Korean patent application No. 10-2009-0061105 filed in the Korean Intellectual Property Office on Jul. 6, 2009, the entire contents of which are incorporated herein by reference.

### BACKGROUND

1. Technical Field

The following disclosure relates to a xenon lamp using a ceramic arc tube.

2. Background Art

Recently, induction fluorescent lamps include QL lamps of PHILIPS, ENDURA of OSRAM or the like, but such induction fluorescent lamps may cause environmental problems since they use mercury (Hg) like an existing fluorescent lamp.

Therefore, light source systems not using mercury are being actively researched.

Among them, xenon is environment-friendly, different from mercury, and has broad optical characteristics from ultraviolet rays to visible rays, without influencing the light emission characteristic due to a surrounding temperature.

Generally, a xenon lamp recently developed may provide available light containing ultraviolet rays and visible rays, generated by a discharge tube which is a plasma generating unit in a bulb, by using a xenon gas.

An induction lamp generally includes a bulb coated with a fluorescent substance at its inner side, and a discharge unit, namely a plasma generating unit having a core and a coil wound around the core at the center of the bulb.

Since the xenon lamp uses a xenon (Xe) gas, the xenon lamp is environment-friendly, does not influence a light emission characteristic due to a surrounding temperature, and has a broad optical characteristic from ultraviolet rays to visible rays (for reference, xenon emits artificial ultraviolet rays of 147, 150, 173 nm in a UV region and emits visible rays of 469, 540, 606, 652 nm).

Therefore, xenon is advantageous in an environment-friendly property due to extremely small mercury or less mercury, high color rendition, a long life cycle, a temperature characteristic, a lighting characteristic or the like.

However, even though such an induction lamp has an extended life cycle due to the absence of an electrode, the induction lamp has disadvantages in that the life cycle of the fluorescent substance is short, that it is impossible to obtain an optimal light emitting efficiency due to the ultraviolet rays passing through the fluorescent substance, and that an energy efficiency is low.

In other words, even though fluorescent material is an essential element in stimulating the fluorescent substance to change ultraviolet rays into visible rays, the fluorescent material limits the emission of visible rays, thereby not giving optimal brightness. This problem must be solved.

### SUMMARY

The present disclosure is designed to solve the above problems, and the present disclosure is directed to configuring an arc tube with a ceramic body made of ceramic, instead of a glass tube of a xenon lamp made of a circular glass tube, wherein the ceramic body has a shape:

[symbol]

so as to greatly extend a life cycle in comparison to the glass tube xenon lamp.

The present disclosure is also directed to connecting a ceramic capsule and a ribbon with a tungsten wire to keep high temperature.

The present disclosure is also directed to connecting a molybdenum wire of a zigzag shape formed in the ribbon to the tungsten wire so that the heat in the ribbon may be emitted more easily.

The present disclosure is also directed to configuring an outer jacket which surrounds the ceramic body to ensure safety at explosion.

The present disclosure is also directed to configuring a UV-shielding glass at the outside of the outer jacket to shield UV emission.

In one general aspect, a xenon lamp using a ceramic arc tube, which has been traditionally formed with a circular glass discharge tube, includes a ceramic body instead of the glass discharge tube, and the ceramic body includes a ceramic capsule made of ceramic and filled with a gas therein; and ceramic pipes made of ceramic, configured to extend at both sides of the ceramic capsule and filled with a gas therein.

By providing the xenon lamp using a ceramic arc tube according to the present disclosure as described above, an arc tube with a ceramic body made of ceramic is configured instead of a glass tube of a xenon lamp made of a circular glass tube, and the ceramic body has a shape

[symbol]

so as to provide a greatly extended life (at least 10 times) in comparison to the glass tube xenon lamp.

In addition, by connecting the ceramic capsule and the ribbon with the tungsten wire, high temperature may be kept.

In addition, by connecting the molybdenum wire of a zigzag shape formed in the ribbon to the tungsten wire, the heat in the ribbon may be more easily emitted.

In addition, by forming the outer jacket to surround the ceramic body, the safety may be ensured at explosion.

In addition, by configuring the UV-shielding glass at the outside of the outer jacket, it is possible to give an effect of shielding UV emission.

### BRIEF DESCRIPTION OF THE DRAWINGS

FIG. 1 is a schematic view showing a xenon lamp using a ceramic arc tube according to an embodiment of the present disclosure.

### DETAILED DESCRIPTION OF EMBODIMENTS

Hereinafter, a xenon lamp using a ceramic arc tube according to an embodiment of the present disclosure will be described in detail with reference to the accompanying drawing.

A xenon lamp using a ceramic arc tube according to an embodiment of the present disclosure, which has been traditionally formed with a circular glass discharge tube, includes a ceramic body instead of the glass discharge tube, wherein the ceramic body includes: a ceramic capsule made of ceramic and filled with a gas therein; and ceramic pipes made of ceramic, configured to extend at both sides of the ceramic capsule and filled with a gas therein.

Meanwhile, a xenon lamp using a ceramic arc tube according to another embodiment of the present disclosure, which has been traditionally formed with a circular glass discharge tube, includes: a ceramic body 100 including a ceramic capsule 110 made of ceramic instead of the glass discharge tube and filled with a gas therein and ceramic pipes 120 made of ceramic, configured to extend at both sides of the ceramic capsule and filled with a gas therein; a ribbon 200 configured to emit high-temperature heat in the ceramic pipe; a tungsten wire 300 configured to connect the ceramic capsule and the ribbon to keep high temperature; a molybdenum wire 400 connected to the tungsten wire, configured in a zigzag shape and welded to a nickel wire 500 through the ceramic pipe; and an outer jacket 600 formed to surround the ceramic body to ensure safety at explosion.

At this time, at the inside of the outer jacket, the outer jacket may be coated with a colorant to emit a light of a desired color.

At this time, at the outside of the outer jacket, a UV-shielding glass may be configured.

At this time, the gas may be a xenon gas.

At this time, the ceramic body may have a shape:

[symbol]

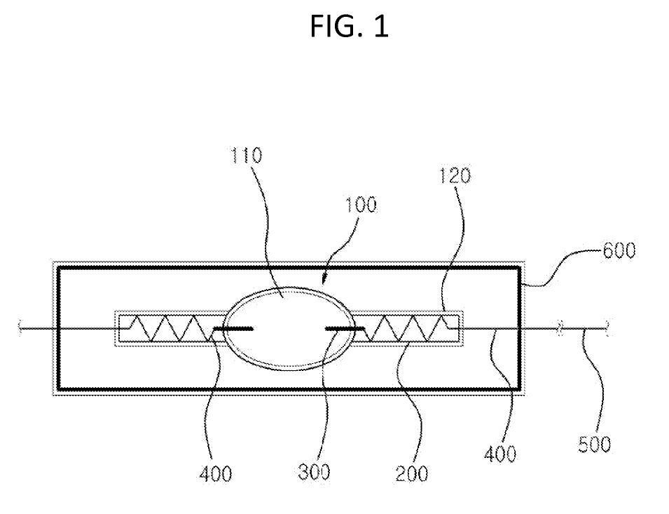

FIG. 1 is a schematic view showing a xenon lamp using a ceramic arc tube according to an embodiment of the present disclosure.

Generally, a xenon lamp includes an arc tube into which a xenon gas is inserted and where discharge occurs, and a tube-shaped outer jacket for protecting the arc tube from the outside.

As shown in FIG. 1, in the present disclosure, the arc tube is configured to have a shape:

where the arc tube is not made of glass material but made of ceramic to solve the problems mentioned above.

In addition, by replacing a traditional glass tube of a xenon lamp with a ceramic discharge tube, it is possible to improve performance and greatly extend a life cycle.

This will be described later in detail.

As shown in FIG. 1, the xenon lamp using a ceramic arc tube according to the present disclosure, which has been traditionally formed with a circular glass discharge tube, includes: a ceramic body 100 including a ceramic capsule 110 made of ceramic instead of the glass discharge tube and filled with a gas therein and ceramic pipes 120 made of ceramic, configured to extend at both sides of the ceramic capsule and filled with a gas therein; a ribbon 200 configured to emit high-temperature heat in the ceramic pipe; a tungsten wire 300 configured to connect the ceramic capsule and the ribbon to keep high temperature; a molybdenum wire 400 connected to the tungsten wire, configured in a zigzag shape and welded to a nickel wire 500 through the ceramic pipe; and an outer jacket 600 formed to surround the ceramic body to ensure safety at explosion.

The ceramic body (the arc tube) includes the ceramic capsule 110 made of ceramic and filled with a gas therein and the ceramic pipes 120 made of ceramic, configured to extend at both sides of the ceramic capsule and filled with a gas therein.

Instead of a glass discharge tube of a traditional xenon lamp formed with a circular glass discharge tube, the ceramic body made of ceramic is configured as the arc tube, and the ceramic body is configured to have a shape:

so as to provide a greatly extended life (at least 10 times) in comparison to the glass tube xenon lamp, and so as to be applicable to a high-capacity xenon lamp.

A general glass discharge tube xenon lamp is deformed if it is used over 1,300 hours.

The ribbon 200 is formed in the ceramic pipe to easily emit high-temperature heat.

The tungsten wire 300 is configured to connect the ceramic capsule and the ribbon, and the molybdenum wire 400 is connected to the tungsten wire, configured in a zigzag shape and welded to the nickel wire 500 through the ceramic pipe.

The molybdenum wire formed in the ribbon has a zigzag shape in order to more easily emit the heat in the ribbon and improve the performance.

In addition, the molybdenum wire is applied to the ribbon in order to facilitate welding and endure high temperature when the molybdenum wire is welded to the tungsten wire.

In addition, the outer jacket 600 is configured to surround the ceramic body in order to ensure safety at explosion.

Meanwhile, the inside of the outer jacket is coated with a colorant so that a light of a desired color may be emit, which may enhance an aesthetic feeling by emitting a light of a suitable color.

Meanwhile, the UV-shielding glass is configured at the outside of the outer jacket, which allows UV emission to be shielded.

Generally, mercury is added as a metal component into the arc tube in order to enhance the brightness of the xenon lamp.

However, in the present disclosure, a mercury-less ceramic discharge tube where no mercury is added into the arc tube is used, thereby providing a more environment-friendly xenon lamp.

a. While the exemplary embodiments have been shown and described, it will be understood by those skilled in the art that various changes in form and details may be made thereto without departing from the spirit and scope of the present disclosure as defined by the appended claims. Therefore, it should be understood that the embodiments described above are just exemplary and not limiting in all aspects.

The scope of the present disclosure is defined in the appended claims, and all changes and modifications derived from the claims and their equivalents should be interpreted as being included in the scope of the present disclosure.

a. By providing the xenon lamp using a ceramic arc tube according to the present disclosure, an arc tube with a ceramic body made of ceramic is configured instead of a glass tube of a xenon lamp made of a circular glass tube, and the ceramic body has a shape

[symbol]

so as to greatly extend a life cycle in comparison to the glass tube xenon lamp, and the same effect may be obtained when being applied to various kinds of lamps.

While the present disclosure has been described with respect to the specific embodiments, it will be apparent to those skilled in the art that various changes and modifications may be made without departing from the spirit and scope of the present disclosure as defined in the following claims.

1. A xenon lamp, comprising:
ceramic body including:
a ceramic capsule made of ceramic and filled with a gas therein; and
ceramic pipes made of ceramic, the ceramic pipes extending at both sides of the ceramic capsule and filled with a gas therein.

2. A xenon lamp, comprising:
a ceramic body including a ceramic capsule and ceramic pipes, the ceramic capsule made of ceramic and filled with a gas therein, the ceramic pipes made of ceramic, extended at both sides of the ceramic capsule and filled with a gas therein;
a ribbon to emit heat in the ceramic pipe;
a tungsten wire connecting the ceramic capsule and the ribbon;
a molybdenum wire connected to the tungsten wire, the molybdenum wire having a zigzag shape and welded to a nickel wire through the ceramic pipe; and
an outer jacket formed to surround the ceramic body to ensure safety at explosion.

3. The xenon lamp according to claim 2, wherein, at the inside of the outer jacket, the outer jacket is coated with a colorant to emit a light of a desired color.

4. The xenon lamp according to claim 2, further comprising, at the outside of the outer jacket, a UV-shielding glass.

5. The xenon lamp according to claim 2, wherein the gas is a xenon gas.

6. The xenon lamp according to claim 2, wherein the ceramic body has a shape of

[symbol]

7. The xenon lamp according to claim 1, wherein the gas is a xenon gas.

8. The xenon lamp according to claim 1, wherein the ceramic body has a shape of

[symbol]

9. The xenon lamp according to claim 1, wherein the ceramic body is free of mercury.

10. The xenon lamp according to claim 2, wherein the ceramic body is free of mercury.
